(19) United States
(12) Patent Application Publication
(10) Pub. No.: US 2016/0154595 A1
(43) Pub. Date: Jun. 2, 2016

(54) DATA ARCHIVE SYSTEM

(71) Applicant: Hitachi-LG Data Storage, Inc., Tokyo (JP)

(72) Inventor: Hisahiro HAYASHI, Tokyo (JP)

(21) Appl. No.: 14/947,103

(22) Filed: Nov. 20, 2015

(30) Foreign Application Priority Data
Nov. 27, 2014 (JP) 2014-240445

(51) Int. Cl. G06F 3/06

(52) U.S. Cl. CPC G06F 3/0619; G06F 3/0656; G06F 3/0689

(57) ABSTRACT

A data archive system comprises a plurality of library apparatuses, a buffer which stores data temporarily and a server which controls the library apparatuses and the buffer. If the data is stored in the buffer, the library apparatus records the data to optical disc(s). In the first controlling state, the buffer stores the data input to the system from the outside, even if at least one library apparatus is powered off. Accordingly, the service to the user for archiving data in the state of offline is provided because it is possible to record and read new data to/from the buffer even if the power source of a library apparatus which is part of a group is turned off.

### CROSS-REFERENCE TO RELATED APPLICATION

This application claims the Japanese Patent Application No. 2014-240445 filed Nov. 27, 2014, which is incorporated herein by reference in its entirety.

### BACKGROUND OF THE INVENTION

1. Field of the Invention

The present invention is related to data archive system which records data to recording medium such as optical disc on a plurality of library apparatuses.

2. Background Art

Recently, archive systems have been used for long term preservation of low accessible data in client's user data, the archive system recording and archiving data on recording medium such as optical disc. JP-A-2013-89275 discloses the technology selecting the disc which is likely to be accessed next based on access history and preparing it toward a drive for accelerating the access to the disc.

### SUMMARY OF THE INVENTION

Data Archive System comprises a plurality of library apparatuses. The each library apparatus is loaded with a cartridge storing a number of optical discs. The plurality of library apparatuses are connected and passing data to user terminal via server and buffer.

Here, the each cartridge storing a number of optical discs is assigned to each user's group for example. A server manages recording and reproducing process in the each user's group. We call the user's group “Share”, and also we call the method of management “Share management” or “Share function”. According to the Share management, the user can easily access the data (cartridge, disc) within the user's group. And also, the Share management makes it possible to keep a security among different user's groups.

In the Share management, it's necessary to stop the Share function when the power source of the library apparatus is turned off for pulling a cartridge from the library apparatus. As a result, it become impossible to archive new data within the user's group (Share) and it also become impossible to reproducing data from another library apparatus even if it is not turned off.

JP-A-2013-89275 does not consider the Share management in archive system and does not mention about the problem regarding to the Share management.

The present invention has for an object to improve the service to user for archiving data into the state of offline for example, by furnishing data archive system which make it possible to record and read new data to/from buffer even if the power source of the library apparatus is turned off on the method of group management.

In order to solve the above described problem, a configuration described in claims is used as an example in the present invention.

According to the present invention, the service to user is improved for archiving data in the state of offline for example. This is because it is possible to record and read new data to/from buffer even if the power source of the library apparatus is turned off on the method of group management.

### BRIEF DESCRIPTION OF THE DRAWINGS

FIG. 1 A view showing an example of data archive system of the present invention

FIG. 2 A view explaining a method of group management in archive system

FIG. 3 A view explaining a transition of state regarding group management (Share) in the embodiment

FIG. 4 A view explaining an operating function in the stop state

FIG. 5 A view explaining an operating function in the partial stop state

FIG. 6A A flowchart showing a procedure preparing volume by conventional method

FIG. 6B A flowchart showing a procedure recording data into disc by conventional method

FIG. 7A A flowchart showing a procedure preparing volume, to which the Partial Stop state is added

FIG. 7B A flowchart showing a procedure preparing volume, to which the Flush Share state is added

FIG. 7C A flowchart showing a procedure preparing volume, to which both the Partial Stop state and the Flush Share state is added

FIG. 8 A flowchart showing a procedure recording data into disc, to which the Flush Share state is added

FIG. 9 A view showing display example of Share size and Buffer size

FIG. 10 A view explaining a method for displaying Share size

### DETAILED DESCRIPTION OF THE INVENTION

Hereinafter, an embodiment of the present invention will be described with reference to the drawings.

### First Embodiment

In the first embodiment, a configuration and an operation of the data archive system (hereinafter called “archive system”) will be described. In this embodiment, although optical disc drive is used as recording medium drive, hard disk drive (HDD) or Solid State Drive (SSD) using semiconductor memory may be employed. Blu-ray Disc (BD; trade mark) is suitable as optical disc because it can be recorded large data.

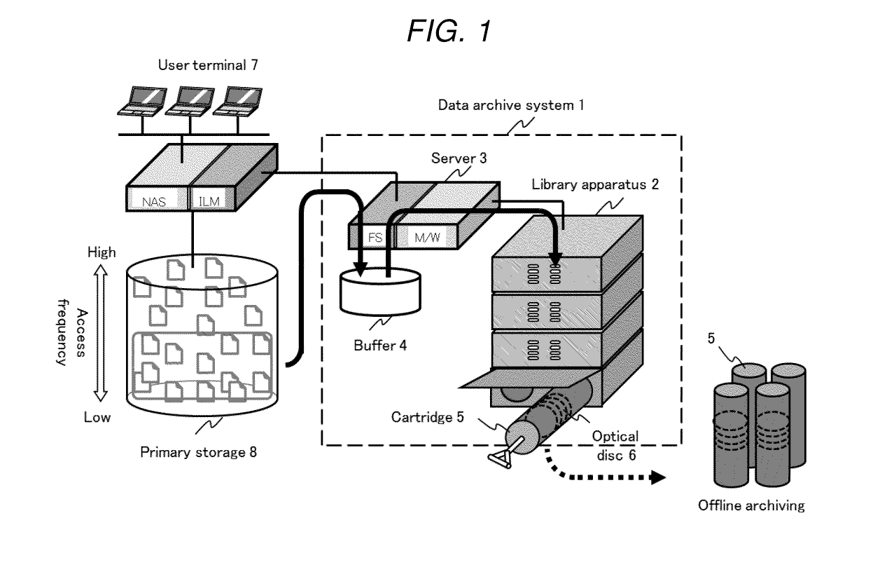

FIG. 1 is a view showing an example of structure of a data archive system. The archive system 1 includes a plurality of library apparatuses 2 which are loaded with cartridges 5 and record and reproduce data, server 3 which controls them, buffer 4 (for example disk array) which temporary stores recording/reproducing data from/to user side. The server 3 includes file system (FS) for conducting management of recording/reproducing data (file) and middleware (M/W) controlling operation of recording/reproducing data from/to the library apparatuses 2 and operation for conveying discs. Each library apparatus 2 can be loaded with two cartridges 5 for example, and each cartridge 5 stores a large number of optical discs 6 (for example, 250 optical discs). Library apparatus 2 includes a plurality of optical disc drives (ODD) (for example, 12 ODDs), extracts the desired optical disc 6 from the cartridge 5, transports it to ODD and conducts recording/reproducing data from/to the optical disc 6. After data are recorded into the optical discs 6 of the cartridge 5, the cartridge 5 can be pulled from the library apparatus 2 and archived in the state of offline. It should be noted that it is necessary to turn off the power source of the library apparatus 2 when pulling the cartridge 5 from the library apparatus 2. This embodiment mentioned below is related to the technology improving usability when conducting offline archiving.

On the user side, user data sent from user terminal 7 is stored in primary storage 8 via NAS (Network Attached Storage) or ILM (Information Lifecycle Management). Then, the data which is not used for predetermined terms or the low accessibility data is selected and sent to the archive system 1, and recording (archiving) of the data is required.

The archive system 1 stores the data (file), which is required to record by user, into the buffer 4 and prepares the volume for recording. After preparing the volume, the archive system assigns the predetermined library apparatus 2 (also predetermined cartridge and disc) and conducts recording process of the data. After completing the data recording, the archive system 1 deletes the data, which have already recorded to disc, in the buffer 4 and prepares and keeps stub file for reproducing the data from the disc 6. If reproducing of the recorded (archived) data is required by the user side, server 3 refers the stub file and produces user data from predetermined disc and supplies the data to user terminal 7.

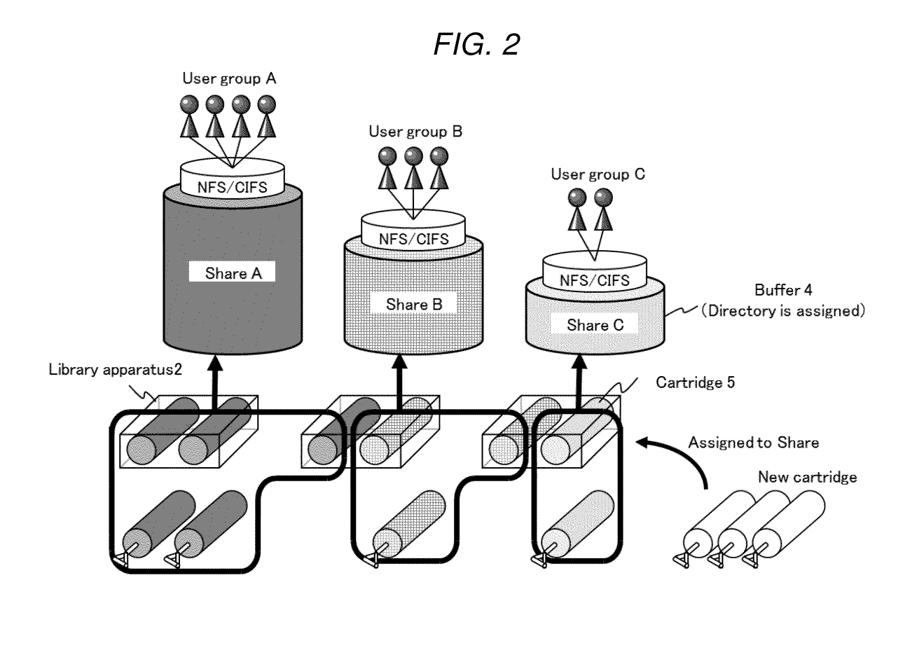

FIG. 2 is a view explaining a method of group management in archive system. In this embodiment, each cartridge 5, in which data is recorded, is assigned to group called “Share”. For example, if data is managed in each user group, for example company or department and so on, it is managed using each Share A, Share B and Share C for user group A, B and C. In this example, although 5 cartridges are assigned to Share A and 3 cartridges are assigned to Share B, cartridges can be additionally assigned according to data size which each user group deals with. In this manner, it is decided unambiguously which Share the each cartridge belongs to. It should be noted that each library apparatus 2 itself does not belong to Share, because any cartridge 5 can be replaced in the library apparatus 2

Directories corresponding to Share management are generated for managing data in the buffer 4 which stores user data temporarily. Then, the user data which is stored in the same directory is recorded into the cartridges which belong to the same Share.

According to group management (Share management) mentioned above, the user can access data (cartridge) in the group which the user belongs to, but cannot access data which belongs to other group. On the other hand, if the Share function is interrupted or stopped, the user cannot access the data which belongs to the user's Share. More specifically, if the Share function is interrupted or stopped, it does not only become impossible to record/reproduce data into/from disc, but also it leads to the state in which it is impossible to access the directory prepared for the user in the buffer 4. This is explained more specifically below.

At first, for example we think of the case where the archive system 1 can set nothing but “Active State” and “Stop State” as state of Share. In this case, the power source of the library apparatus 2 must be turned off when pulling a cartridge 5 from the library apparatus 2. That is why, it is necessary to set “Stop State” in which the function of the corresponded Share is stopped and all services for the user are stopped. So, in this case, it does not only become impossible to record/reproduce data into/from the cartridges belongs to the same Share in other library apparatus 2 which is powered ON, but also it leads to the state in which user cannot access the corresponded Share (cannot access the directory in the buffer) and it is impossible to store data into buffer 4.

Therefore, in this embodiment, the usability and service are improved when archiving data in the state of offline by making a part of Share function effective even if the power source of the library apparatus is turned off.

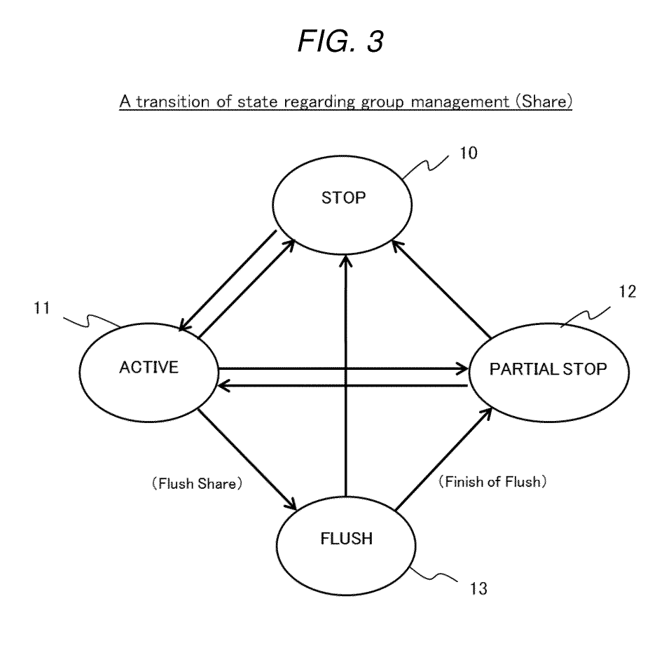

FIG. 3 is a view explaining a transition of state regarding group management (Share) in this embodiment. The conventional group management can set nothing but “Active” state 11 in which the Share function performs and “Stop” state 10 in which the Share function stops. As mentioned above, in the Active State 11, user can access the data (buffer or cartridge) in the Share which the user belongs to, and it is possible to record/reproduce the data into/from cartridge (disc). On the other hand, in the Stop State 10, user cannot access the data in the Share which the user belongs to because the Share function stops. Then, it is impossible to refer the directory in the buffer and to record/reproduce the data into/from cartridge (disc).

On the other hand, in this embodiment, “Partial Stop” state 12, in which a part of Share function is stopped, and “Flush” state 13, in which data recording into disc is conducted promptly, are added as the function. The Partial Stop state 12 means the state, in which it is banned to record data to the library apparatus 2 which is powered ON in the Share which the user belongs to, but it is permitted to access the buffer 4 and to reproduce the data from library apparatus 2 which is powered ON. For this reason, it is possible to store data in buffer 4 and to reproduce data from other library apparatus even if one library apparatus is powered off. Then, it is not necessary to stop the all services for user. That is why the usability for user is improved when archiving data in the state of offline.

The Flush state 13 is the function in which the data recording into disc 6 is conducted promptly, the data planned to record and already stored in buffer 4. Here, we call the operation “Flush Share”, the operation switching the state from Active state 11 to Flush state 13. This makes it possible to shorten the waiting time for recording data into the disc 6. Especially, this is effective when the library apparatus 2 is powered off to exchange the cartridge 5. It should be noted that the new data input into buffer 4 in the Flush state 13 is not recorded to disc 6 but just stored in the buffer 4.

As the transition of state, the state can transit from the Active state 11 to the Partial Stop state 12, and after that, the Partial Stop state 12 can go back to the Active state 11 or the Stop State 10. And also, the state can transit from the Active state 11 to the Flush state 13 (Flush Share), and after that, the Flush state 13 can transit to the Partial Stop state 12 or go back to the Stop State 10. The system administrator can let the system conduct the new function mentioned above by setting the Partial Stop state 12 or the Flush state 13 as the system operation state. By this way, it improves the usability and service to user by adding the Partial Stop state 12 and the Flush state 13 as the system operation state. The function in each state of group management (Share management) is explained specifically below.

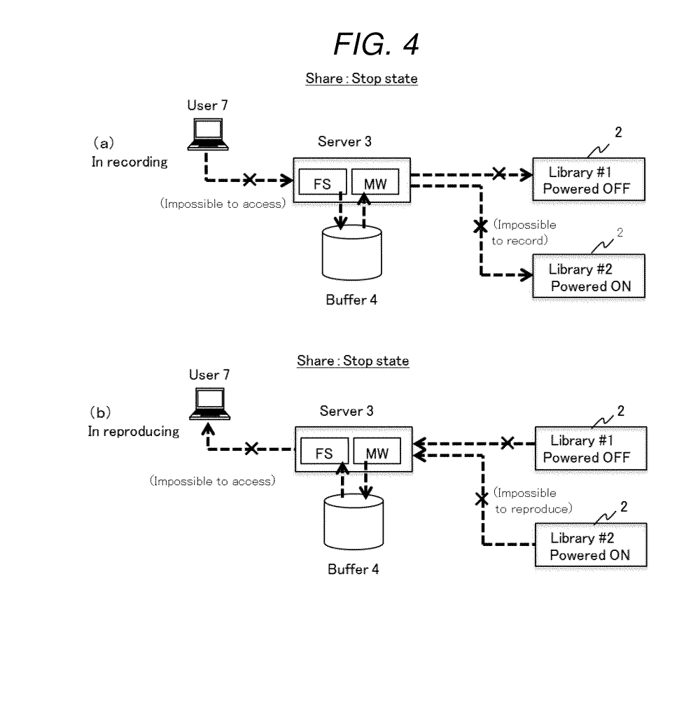

FIG. 4 is a view explaining an operating function in the Stop state. In the FIG. 4, (a) shows a view in recording, and (b) shows a view in reproducing. In the figure, the dashed line between devices indicates impossibility to access (impossibility of data transmission). In the Stop state, the user 7 cannot access the buffer 4 via the server 3. Therefore, it is impossible not only to record/reproduce data in the library apparatus 2 which is powered ON, but also to store data into buffer 4.

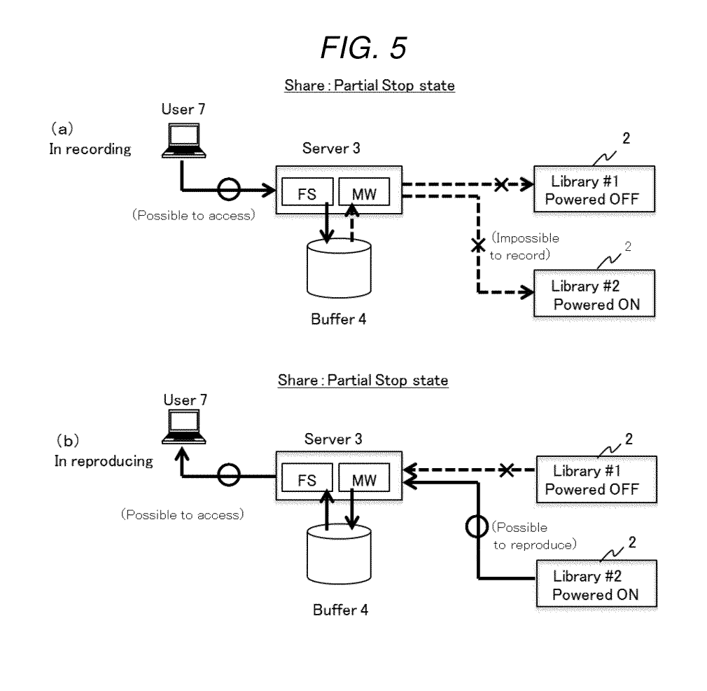

FIG. 5 is a view explaining an operating function in the Partial stop state. In the FIG. 5, (a) shows a view in recording, and (b) shows a view in reproducing. In the figure, the solid line between devices indicates that it can be accessed (data transmission is possible). In the Partial stop state, the user 7 can access the buffer 4 via the server 3. Therefore, In the situation (a) of recording, it is possible to store data into the buffer 4. However, it is impossible to record data into library apparatus 2 even which is powered ON. In the situation (b) of reproducing, it is possible to reproduce data from buffer 4 and also from library apparatus 2 which is powered ON.

Hereinafter, the recording operation of user data in this embodiment (in which the Partial stop state and Flush state are added) will be described in comparison with the conventional method (in which there are the Active state and Stop state only). The recording operation of data is conducted by file system FS and middleware M/W in the server 3. And the recording operation is divided into two steps, the volume preparing step within the buffer 4 and the recording step to disc 6 in the library apparatus 2. In this explanation, it will be mainly described how input user data is treated in the buffer 4 and recorded to disc 6 in terms of the timing of operation.

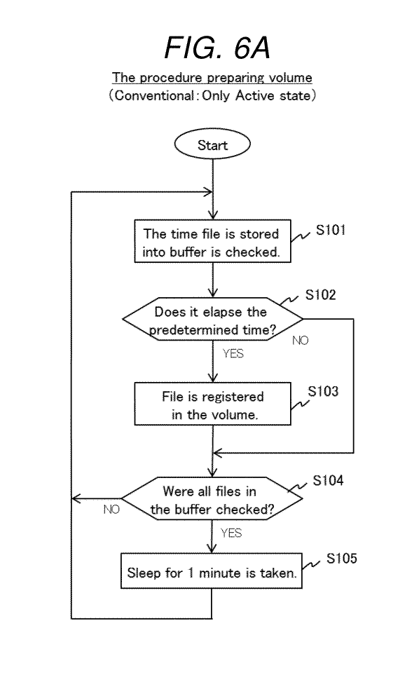

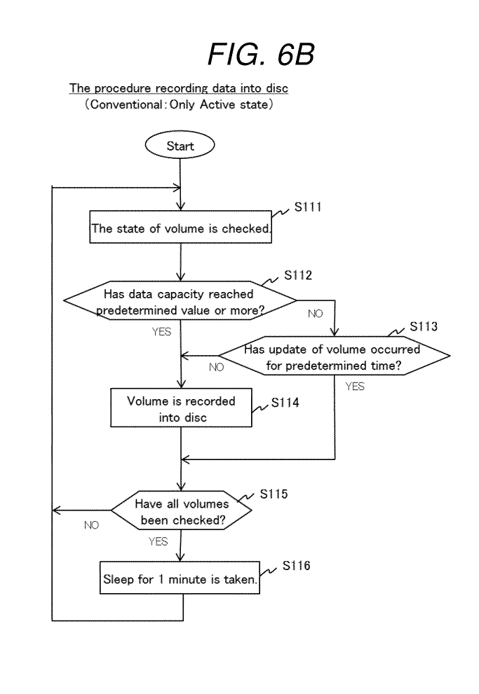

FIG. 6A and FIG. 6B are flowcharts showing data recording operation by conventional method. FIG. 6A shows a procedure preparing volume and FIG. 6B shows a procedure recording data into disc.

The procedure preparing volume in FIG. 6A will be described below. In S101, the time each file (user data), which is input to the buffer 4, are stored into the buffer 4 is checked. In S102, it is determined whether it elapses the predetermined time or not. For example, the predetermined time is set to 1 hour. In S103, the file predetermined time has elapsed is registered in the volume and assigned to the disc which is a destination of recording. The process of registering volume is conducted by middleware M/W in server 3. In step 104, the process mentioned above is conducted regarding all files in the buffer 4. After conducting the process of all files, sleep for predetermined time (1 minute) is took in S105, and these processes go back to S101, and repeat the process. According to this flow, the file, which is stored in buffer 4 and predetermined time (1 hour) has elapsed, becomes the state registered in the volume.

The procedure recording data into disc in FIG. 6B will be described below. In S111, the state of each volume in buffer 4 is checked. In S112, it is determined whether the data size of the volumes has reached a predetermined value (threshold) or more. The predetermined value is set in advance based on data recording size of the disc, for example it is set to the value, 80% of the disc size and so on. When the data size of the volumes is less than the predetermined value, it is determined whether update of volume (registration of file) has not occurred for predetermined time in S113. For example, the predetermined time is set to 24 hours. If the data size of the volumes has reached a predetermined value or more in the decision in S112, or if it has elapsed the predetermined time since last update of volume in S113, the step moves to S114.

In S114, the volume is recorded into the disc 6. At first, the file system FS requires the middleware M/W to record the volume into disc 6. Then, the middleware requires the predetermined library apparatus 2 to record data of the volume. Herewith, the library apparatus 2 records the data into the predetermined disc 6 in the predetermined cartridge 5. After completing the data recording to the disc, the file which has been stored in the buffer 4 is deleted and the stub file (corresponding to short cut file) is prepared. The stub file is the information necessary for reproducing the data, including the information of disc 6 which is destination of the recording, for example.

In S115, the processes are conducted regarding all volumes in the buffer 4. After conducting the processes of all volumes, sleep for predetermined time (1 minute) is took in S116, and these processes go back to S111, and repeat the process.

According to this flow, when the data size of the volumes has reached a predetermined value or it has elapsed the predetermined time since previous update of the volume, the files which are registered in the volume are recorded to the disc 6 by the library apparatus 2. In this process, user data stored in the buffer 4 is not immediately recorded to the disc 6, and is made to wait a while in the period within the buffer 4. This is because it is more efficient to record large data or a plurality of data consecutively rather than to record small data in many times in terms of shortening of overhead (seeking time of ODD, for example) in the recording process. To use the size of the disc 6 efficiently, whether the size of the volume reaches the predetermined value or more are included in the criteria of the decision. Even if the size of the volume has not reached the predetermined value or more, it is started recording the data relative to the volume which has elapsed the predetermined time to the disc 6 in order to avoid recording waiting volume persist in the buffer 4.

In the conventional data recording method in FIG. 6A and FIG. 6B, when the library apparatus powered off to exchange the cartridge, it is a must to record the data (registered in volume), which is stored in buffer 4 for recording, into disc in advance, for example. For this reason, exchange of cartridges is impossible until it elapses predetermined time (24 hours) in S113 and data recording process finishes in S114. Therefore, this leads to inconvenience for user.

In this embodiment, this problem is settled by adding Partial stop state and Flush share state. Data recording process in this embodiment will be described below.

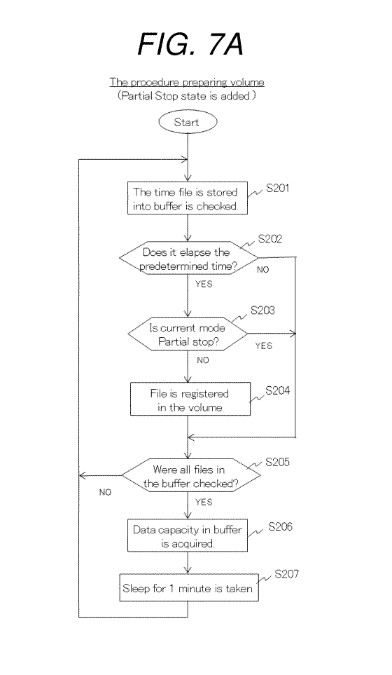

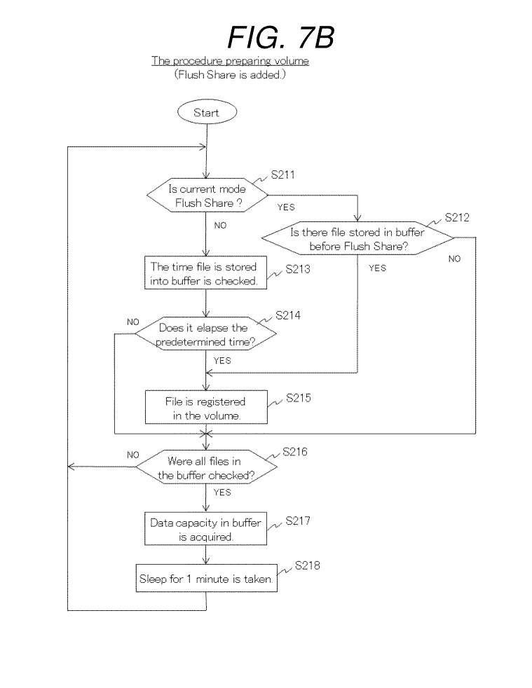

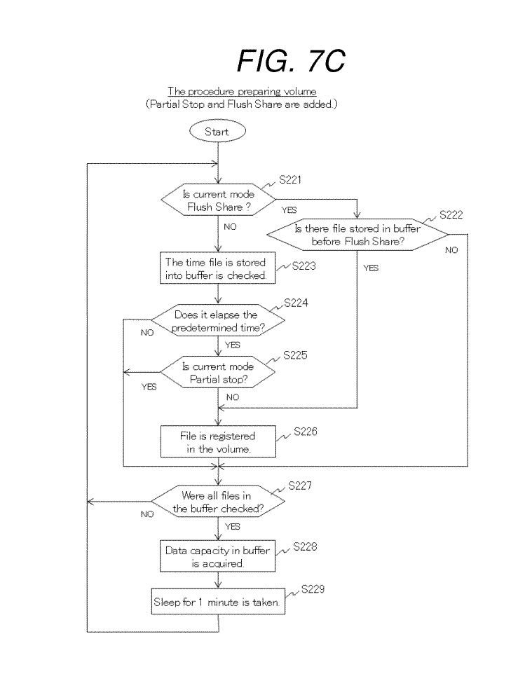

FIG. 7A is a flowchart showing a procedure preparing volume, to which the Partial Stop state is added.

In S201, the time each file (user data), which is input to the buffer 4, are stored into the buffer 4 is checked. In S202, it is determined whether it elapses the predetermined time (for example, 1 hour) or not. If there is a file which has elapsed the predetermined time, it is determined whether current operating mode is Partial stop state or not in S203. If that is not Partial stop state, it moves to S204 and the file is registered to the volume (corresponding to S103 in FIG. 6A). If that is Partial stop state in decision of S203, it skips S204 and moves to S205. Therefore, new volume is not prepared in Partial stop state even if there is a file which has elapsed the predetermined time.

In S205, the processes are conducted regarding all files in the buffer 4. Then, data size in the buffer 4 is acquired in S206. This is because it reflects the data size stored in the buffer 4 for size used in Share as well. Sleep for predetermined time (1 minute) is taken in S207, and these processes repeat. According to this flow, new volume is not prepared in Partial stop state. That is why recording process to disc does not occur as a result.

FIG. 7B is a flowchart showing a procedure preparing volume, to which the Flush Share state is added.

In S211, it is determined whether current operating mode is Flush Share state or not. If that is Flush Share state, it moves to S212 and it is determined whether there is a file which is stored in buffer 4 before conducting Flush Share. If there is a file which is stored like that, it moves to S215 and the file is registered to volume. In this way, the data which have already stored in buffer 4 is registered immediately to the volume without waiting predetermined time (for example 1 hour). If there is not a file which is stored before conducting Flush Share in the decision of S212, it skips S215 and moves to S216. In another word, the file which is stored in buffer 4 after conducting Flush Share is not registered to the volume. In such situation, recording to disc does not occur as a result.

If that is not Flush Share state in decision of S211, it moves to S213. In S213, the time file is stored into the buffer 4 is checked. In S214, it is determined whether it elapses the predetermined time (for example, 1 hour) or not. If there is a file which has elapsed the predetermined time, it moves to S215 and the file is registered to the volume (corresponding to S103 in FIG. 6A).

In S216, the processes are conducted regarding all files in the buffer 4. Then, data size in the buffer 4 is acquired in S217. This is because it reflects the data size stored in the buffer 4 for size used in Share as well. Sleep for predetermined time (1 minute) is taken in S218, and these processes go back to S211, and repeat the process.

According to this flow, the files which have already been stored in buffer 4 in Flush Share state is immediately registered to the volume. Therefore, this shortens the time for recording process to disc as a result.

FIG. 7C is a flowchart showing a procedure preparing volume, to which both the Partial Stop state and the Flush Share state is added. This is contents of combination of procedures in FIG. 7A and FIG. 7B.

In S221, it is determined whether current operating mode is Flush Share state or not. If that is Flush Share state, it moves to S222 and it is determined whether there is a file which is stored in buffer 4 before conducting Flush Share. If there is a file which is stored like that, it moves to S226 and the file is registered to volume (corresponding to S212, S215 in FIG. 7B). In this way, the data which have already stored in buffer 4 is registered immediately to the volume without waiting predetermined time (for example 1 hour). If there is not a file which is stored before conducting Flush Share in the decision of S222, it skips S226 and moves to S227. In another word, the file which is stored in buffer 4 after conducting Flush Share is not registered to the volume. In such situation, recording to disc stops as a result.

If that is not Flush Share state in decision of S221, it moves to S223. In S223, the time file is stored into the buffer 4 is checked. In S224, it is determined whether it elapses the predetermined time (for example, 1 hour) or not. If there is a file which has elapsed the predetermined time, it is determined whether current operating mode is Partial Stop state or not in S225. If that is not Partial Stop state, it moves to S226 and the file is registered to the volume (corresponding to S103 in FIG. 6A).

If that is Partial stop state in decision of S225, it skips S226 and moves to S227 (corresponding to S203, S205 in FIG. 7A). Therefore, new volume is not prepared in Partial stop state even if there is a file which has elapsed the predetermined time. In S227, the processes are conducted regarding all files in the buffer 4. Then, data size in the buffer 4 is acquired in S228. Sleep for predetermined time (1 minute) is taken in S229, and these processes go back to S221, and repeat the process.

According to this flow, the decision whether that is Flush Share state or not takes priority and the files which have already been stored in buffer 4 in Flush Share state is immediately registered to the volume. Therefore, this shortens the time for recording process to disc as a result. If that is not Flush Share state but Partial Stop state, new volume is not prepared and recording to disc does not occur as a result.

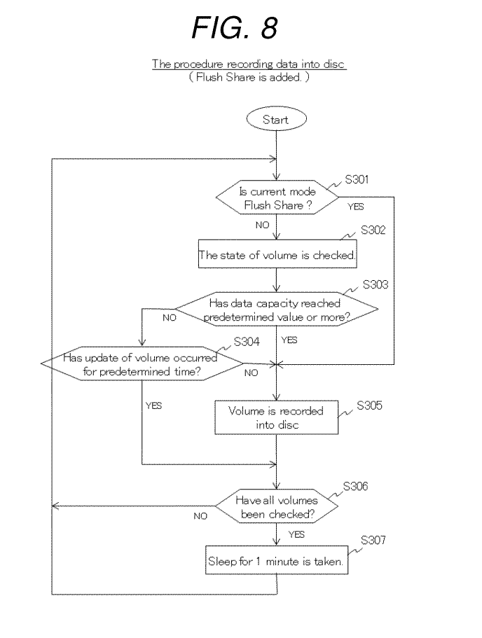

FIG. 8 is a flowchart showing a procedure recording data into disc, to which the Flush Share state is added. This is a procedure which records the volume prepared in the buffer 4 into disc following the procedures in previous FIG. 7A˜7C.

In S301, it is determined whether current operating mode is Flush Share state or not. If that is Flush Share state, it moves to S305 regardless of the volume state in the buffer 4, and the volume is recorded into the disc 6 (corresponding to S114 in FIG. 6B). At first, the file system FS requires the middleware M/W to record the volume into disc 6. Then, the middleware requires the predetermined library apparatus 2 to record data of the volume. Herewith, the library apparatus 2 records the data into the predetermined disc 6 in the predetermined cartridge 5. After completing the data recording to the disc, the file which has been stored in the buffer 4 is deleted and the stub file (corresponding to short cut file) is prepared.

If that is not Flush Share state in decision in S301, it moves to S302 and the process proceeds according to the state of volume. In S302, the state of each volume is checked. In S303, it is determined whether the data size of the volumes has reached a predetermined value (threshold) or more. The predetermined value is set in advance based on data recording size of the disc. When the data size of the volumes is less than the predetermined value, it is determined whether update of volume (registration of file) has not occurred for predetermined time (for example, 24 hours) in S304. If the data size of the volumes has reached a predetermined value or more in the decision, or if it has elapsed the predetermined time since last update of volume, the volume is recorded into disc 6 in S305.

In S306, the processes are conducted regarding all volumes in the buffer 4. After conducting the processes of all volumes, sleep for predetermined time (1 minute) is took in S307, and these processes go back to S301, and repeat the process.

According to this flow, the data registered to volume in the buffer 4 in Flush Share state can be immediately recorded to disc 6 by the library apparatus 2. In another words, this can drastically shorten the waiting time for turning off the power source of the library apparatus to exchange the cartridge, because data recording to disc can be immediately conducted without waiting predetermined time (for example 24 hours). Therefore, the service to user is improved. If that is not Flush Share state, as usual, when the data size of the volumes has reached a predetermined value or more in the decision, or when it has elapsed the predetermined time, the volume is recorded into a disc.

### Second Embodiment

In the second embodiment, the display of the current size of Share and the current size of the buffer in the archive system will be described. The server 3 displays the data size which is recorded into the disc 6 and the data size which is stored in the buffer 4 on a display of the user terminal 7. That is why user can be aware of the recording state or storing state of current data.

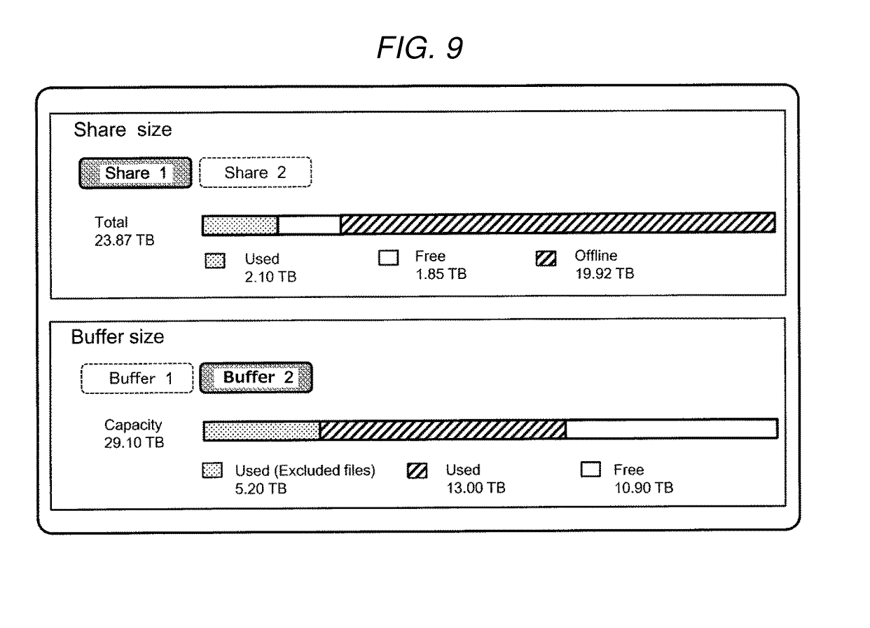

FIG. 9 is a view showing display example of Share size and Buffer size.

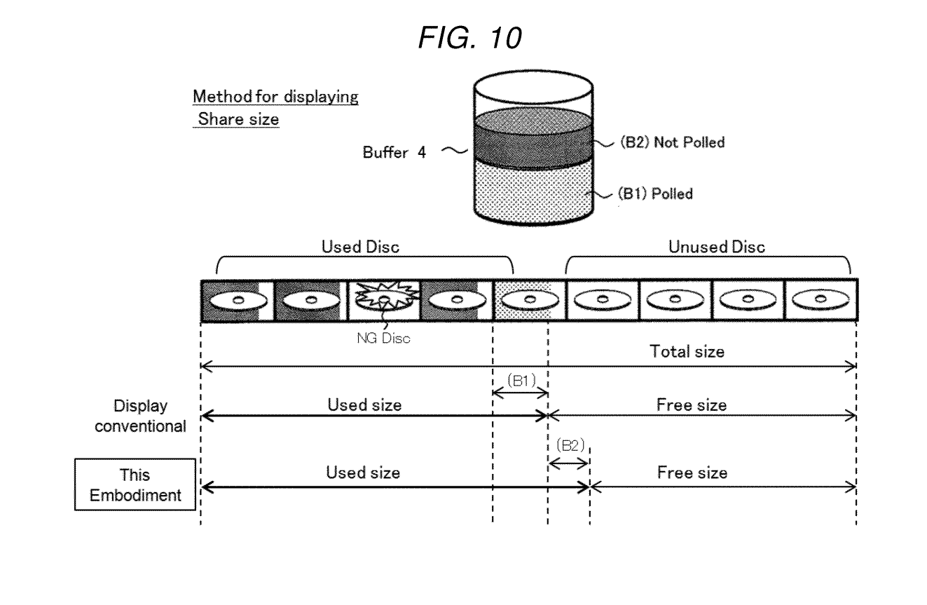

The Share size above in the view indicates the size of Share divided into “Used”, “Free” and “Offline” regarding the discs in the cartridge assigned to the user group (Share). “Used” which is displayed in the Share size includes not only the data size which has been already recorded into the disc but also the data size which is stored in the buffer 4 for the future recording. In Partial Stop state in the first embodiment, the data in the buffer 4 can keep on increasing. Therefore, there is a risk that the larger size of data is stored in the buffer 4 than the available size of the disc 6. To avoid this, the data size in the buffer 4 is monitored and “Used” is displayed for user in the state in which the data size stored in the buffer 4 for the future recording is added to “Used”. When “Free” which is the available size of the disc 6 decreases, a warning is generated. The method to calculate this size will be described in FIG. 10.

The Buffer size below in the view indicates the data size stored in the buffer 4, divided into “Used” and “Free” in each corresponding Share. It should be noted that “Used (Excluded files)” which is the data other than files in used data is separately displayed because it is not data which will be recorded into disc and it does not decrease even if recording process starts.

FIG. 10 is a view explaining a method for displaying Share size. Share size is calculated from the number of discs which are “Used” and “Free”. In this embodiment, “Used size” is displayed, where the “Used size” includes the data which is planned to be recorded to disc. This data which is planned to be recorded will be described.

There are B1 (Polled) state and B2 (Not Polled) state as a state of data stored in the buffer 4. B1 state is the state in which files stored in the buffer 4 are registered to volume (the state in which the disc for recording the files is assigned by the middleware M/W). B2 state is the state in which files stored in the buffer 4 are not registered to volume yet (the state in which the files is recognized by file system FS).

In the conventional display, “Used” is displayed, where the “Used” includes B1 (Polled) state. However, in this embodiment, “Used” is displayed, where the “Used” includes not only B1 (Polled) state but also B2 (Not Polled) state. In another word, “Used” is displayed so that it includes the files which are not registered to volume and to which the disc for recording is not assigned. The data size in the buffer 4 is acquired to calculate the data size of B2 state in the procedure preparing volume (S206 in FIG. 7A, S217 in FIG. 7B and S228 in FIG. 7C).

According to the second embodiment, used disc size is displayed so that data size in the buffer 4 which is planned to be recorded to disc is included used disc size. By this way, user can be aware of it with accuracy in advance whether data stored in the buffer 4 exceed the available size of the disc 6 or not even if data in buffer 4 keeps on increasing in Partial Stop state due to the operation for archiving data into the state of offline (pulling a cartridge from the library apparatus) for example. Therefore, this makes it possible to prevent the stored data from overflowing in advance.

It should be noted that the data archive system need not to comprise display unit itself in this embodiment. The data archive system need to comprise at least the unit to output the display information mentioned above to outside. Furthermore, file system FS and middleware M/W are described separately in each function in this embodiment, but they can be same software. On the other hand, a part of these functions can be conducted in other software.

The present invention is not limited to the above embodiments and various modifications are contained therein. For example, the embodiments are described in detail for easy understanding of the present invention and are not necessarily limited to provision of all the structure described. Moreover, part of the structure of an embodiment may be replaced by the structure of another embodiment and further the structure of an embodiment may be added to the structure of another embodiment.

What is claimed is:

1. A data archive system for recording and reproducing data to/from a plurality of optical discs, comprising;
a plurality of library apparatuses,
a buffer which stores data temporarily, and
a server which controls the library apparatuses and the buffer;
wherein the library apparatus comprises a plurality of optical disc drives which record and reproduce data to/from the optical disc, and a cartridge which stores a plurality of optical discs and which is exchangeable for the library apparatus,
wherein the server controls the buffer so as to store the data input from outside,
wherein if the data size stored in the buffer reaches predetermined value or if predetermined time elapses, the server sends the data stored in the buffer to the library apparatus and controls the library apparatus so as to record the data to predetermined optical disc and reproduce the data recorded to the predetermined optical disc, and
wherein the data archive system comprises first controlling state in which the server controls the buffer in the first controlling state so as to store the data input from outside, even if at least one library apparatus is powered off.

2. The data archive system according to claim 1,
wherein the server controls active library apparatus in the plurality of library apparatuses so as to reproduce data from optical disc in the first controlling state.

3. The data archive system according to claim 1,
wherein the server manages data for recording in each group, and
wherein the first controlling state is applied to the range within the library apparatuses and the buffer in the same group.

4. The data archive system according to claim 3,
wherein when the server output the information indicating the used size which is the data size of used disc in each group, the used size includes not only the size of data which has already been recorded to actual disc but also the size of buffer data which is planned to be recorded to the disc.

5. The data archive system according to claim 3,
wherein the data archive system comprises second controlling state in which the server controls the library apparatus so as to record the buffer data which is planned to be recorded to the disc, even if the data size in the buffer has not reached a predetermined value, or even if it has not elapsed the predetermined time.

6. The data archive system according to claim 5,
wherein the server controls the library apparatus so as to record the buffer data which is planned to be recorded to the disc in the second controlling state and the data archive system transits the first controlling state from the second controlling state before exchanging the cartridge in the library apparatus.
